(19) United States
(12) Patent Application Publication
(10) Pub. No.: US 2004/0141908 A1
(43) Pub. Date: Jul. 22, 2004

(54) Aerogel and metallic composites

(76) Inventors: Hiroaki S. Hara, West Hartford, CT (US); Xing Dong, Willimantic, CT (US)

Correspondence Address: McCormick, Paulding & Huber LLP, CityPlace II, 185 Asylum Street, Hartford, CT, 06103, US

(21) Appl. No.: 10/695,214

(22) Filed: Oct. 28, 2003

Related U.S. Application Data
(63) Continuation-in-part of application No. 10/327,300, filed on Dec. 20, 2002.

(51) Int. Cl. C01B 31/02

(52) U.S. Cl. 423/445 R

(57) ABSTRACT

A fuel cell electrode catalyst comprises a supporting structure made of a metallic composition of carbon aerogel wherein the carbon aerogel has a surface area of greater than about 400 square meters per gram (m²/g) and a pore size of greater than about 4 nm and up to about 50 nm. The crystals of a metal dispersed on the supporting structure are about 1 nm to about 3 nm in diameter. A membrane electrode assembly for a fuel cell comprises a solid electrolyte membrane and catalyst paste, slurry, or ink, disposed on the solid electrolyte membrane wherein the catalyst paste, slurry, or ink comprises a metallic composition of carbon aerogel in powder form and unagglomerated solid electrolyte and solvent dispersed within the carbon aerogel structure.

### CROSS REFERENCE TO RELATED APPLICATION

This application is a continuation-in-part application of Ser. No. 10/327,300, filed on Dec. 20, 2002, the contents of which are incorporated herein by reference in their entirety.

### FIELD OF THE INVENTION

The present invention generally relates to aerogel compositions and, more particularly, to the application of platinum-dispersed carbon aerogels for use as fuel cell electrode catalysts.

### BACKGROUND OF THE INVENTION

Aerogels are porous materials that are produced by polycondensation reactions known as “sol-gel processes.” A common feature among aerogels is their small inter-connected pores. The three major types of aerogels are inorganic, organic, and carbon aerogels. Inorganic aerogels can be obtained by supercritical drying of highly cross-linked and transparent hydrogels synthesized by polycondensation of metal alkoxides. Silica aerogels are the most well known inorganic aerogels. Organic aerogels can be synthesized by supercritical drying of the gels obtained by the sol-gel polycondensation reaction of monomers such as, for example, resorcinol with formaldehyde, in aqueous solutions. Carbon aerogels can be obtained by pyrolizing the organic aerogels at elevated temperatures. Carbon aerogels are the only electron conductive aerogels, therefore since their discovery, they have been suggested for use as electrodes for fuel cells or for super-capacitors because of their mesoporous structure.

Fuel cells have been receiving increasing amounts of attention as one possible alternative power source for stationary and mobile applications due to their high efficiency and environmentally friendly properties. Various types of fuel cells exist. In a proton exchange membrane (“PEM”) fuel cell (a low-temperature hydrogen fuel cell), hydrogen gas at the anode generates electrons and protons with the aid of a catalyst. Subsequently, protons travel through an electrolytic polymer membrane, and the electrons are conducted through an external circuit to the cathode. At the cathode, the transferred electrons and protons react catalytically with oxygen to form water. The current generated by the electrons flowing through the external circuit can be used for work. In a direct methanol (DM) fuel cell, the cells are similar to those of a PEM fuel cell in that a polymer membrane is again used as the electrolyte. In the DM fuel cell, however, the anode catalyst itself draws hydrogen from liquid methanol fed as the fuel.

In the field of mobile applications, though very promising, fuel cells are still too expensive to compete with conventional internal combustion engines. Currently, the only effective catalysts for fuel cells are of expensive noble metal, such as platinum. Because of the high cost due to the high loading amount of such noble metal, widespread commercial use of catalysts in fuel cells manufactured under current technology is not practical. Effort has been made to reduce the amount of platinum loading on the fuel cell membrane electrode assembly (MEA). Carbon supported platinum catalyst, which consists of micron or sub-micron carbon powder that supports small platinum particles on its surface, has shown much higher activity than platinum black catalyst. However, the performance increase of such catalyst is limited by the structure of such carbon support.

Carbon powder supported platinum catalysts are commonly prepared using various impregnation/reduction methods. A typical procedure involves impregnation of powdered carbon by solutions of platinum salts followed by reduction of the metal ions to the metal. In the fuel cell, only the catalyst metal atoms such as platinum atoms that contact the electrolyte have activity. Therefore, in order to maximize the platinum utilization, the addition of an electrolyte (such as unagglomerated polymer electrolyte, e.g, dispersed Nafion® solution), into the electrode, is a common step. Usually the electrolyte is introduced by an impregnation method. One way of impregnating the electrolyte onto the electrode is to contact (e.g., brush, spray, or float/dip) the electrode with the electrolyte solution. Another way is to mix the supported catalyst with the electrolyte directly. Other methods to introduce the electrolyte into the electrode include the sputter-deposition of the catalyst directly on the membrane surface or electrical deposition of the catalyst through the electrolyte onto the electrode. However, it was found that in such methods, the effective utilization of the catalyst is still very low. The structure of carbon which supports the catalyst metal does not allow the majority of the deposited catalytic metal to contact the electrolyte and still maintain electron conductivity and gas accessibility.

Thus, what is needed is an aerogel composition having metallic particles, e.g., platinum, dispersed within the aerogel, such metallic particle being of decreased size and having a narrow metallic particle size distribution so as to provide effective performance in fuel cell applications.

Furthermore, desired carbon aerogel catalytic metal composite in the MEA of the fuel cell is needed to achieve good proton and gas accessibility to the catalytic sites as well as electronic path continuity. Therefore, specification of such carbon aerogel composition as well as the processes for making such carbon aerogel catalytic composition are also needed.

### SUMMARY OF THE INVENTION

Aerogel compositions comprise an aerogel having metallic particles dispersed on the inside surface of the aerogel, i.e., in the pores, wherein the metallic particles have an average particle size of about 4 nanometers (nm) or less, based on the number of metallic particles. Typically, the average particle size of the metallic particles is about 3 nm or less, preferably from 1 to 2 nm, and more preferably about 1 nm.

In one aspect of the present invention, a fuel cell electrode catalyst comprises a supporting structure made of carbon aerogel ground powder wherein the carbon aerogel has a surface area of greater than about 400 square meters per gram (m²/g ) and an average pore size of greater than about 4 nm and smaller than about 50 nm, and metal particles dispersed on the supporting structure. The metal particles are about 1 nm to about 3 nm in diameter.

In another aspect of the present invention, an MEA for a fuel cell comprises a solid electrolyte membrane and a catalyst layer disposed on the solid electrolyte membrane, wherein the catalyst layer comprises a supporting carbon structure, i.e., carbon aerogel, the carbon aerogel having a mesoporous surface area of greater than about 400 m²/g, a pore size of greater than about 4 nm, and metal particles dispersed on the supporting structure, the metal particles being about 1 nm to about 4 nm in diameter and molecules of solid electrolyte such as Nafion® being dispersed within such mesoporous space.

One advantage of a fuel cell catalyst as described herein in the MEA is that overall fuel cell costs may be lowered. In particular, cost savings can be realized as a result of several approaches of implementation of such an electrode, namely, through the reduction of loaded catalyst metal and the simplification of the cell design and manufacturing process. Under high production, simplification of the cell design and manufacturing process is achieved by standardization of both the design and process.

Another advantage is that increased fuel cell performance may be realized. Because of the mesoporous structure of the conductive carbon aerogel, electro-catalytic three-phase contact may be achieved easily. In other words, the catalytic metal, the electrolyte, and the conductive carbon support are all in contact with each other. The structure can provide optimized conditions for such three-phase contact, thereby providing a catalyst layer that realizes increased reaction kinetics.

### BRIEF DESCRIPTIONS OF THE DRAWINGS

FIG. 1 is an exploded schematic representation of a fuel cell.

FIG. 2 is a cross sectional representation of a fuel cell.

FIG. 3 is an HRTEM image of the catalyst ink of 33% Pt on 16 nm CA.

FIG. 4 is a cyclic voltammogram of a membrane electrode assembly using platinum loaded carbon aerogel as a cathode catalyst.

FIG. 5 is a graph of cell voltage versus current density and indicates fuel cell performance.

### DETAILED DESCRIPTION OF THE PREFERRED EMBODIMENTS

Disclosed herein are aerogels and metallic compositions thereof for use in fuel cell applications. Aerogels may be either inorganic (e.g., silica-, alumina-, titania-, vanadia-, niobia-, zirconia-, or tantala-based) or organic (e.g., derived from organic constituents). Silica-based inorganic aerogels are typically derived using precursors or monomers such as tetramethyl orthosilicate (TMOS, Si(OCH₃)₄), tetraethyl orthosilicate (TEOS, Si(OCH₂CH₃)₄), combinations of the foregoing orthosilicates, or the like. Organic aerogels (particularly RF aerogels) may be pyrolized to form carbon-based aerogels. As used herein, the term “aerogel” is intended to indicate all aerogel forms including, but not limited to, inorganic aerogels, organic aerogels (particularly carbon aerogels), and xerogels (gels formed when hydrogels are air dried as opposed to supercritically dried).

Organic aerogels may be produced by the reaction of any one or a combination of various monomers in an appropriate ratio with formaldehyde, furfural, or the like in the presence of a catalyst via a polymerization reaction (e.g., a polycondensation reaction). The monomer(s) is preferably a polyhydroxybenzene compound, exemplary embodiments of which include, but are not limited to, resorcinol, phenol, catechol, chloroglucinal, combinations thereof, and the like. Reaction of such monomers with formaldehyde or furfural generally produce, for example, resorcinol-furfural, resorcinol-formaldehyde, phenol-resorcinol-formaldehyde, catechol-formaldehyde, chloroglucinol-formaldehyde, or the like.

In one exemplary polymerization reaction to form an organic aerogel, the reactants (i.e., the monomers) are mixed with the catalyst to produce the aerogel in the form of a monolithic gel, which is then dried by solvent exchange and extraction. The resulting organic aerogel is then pyrolized in an inert atmosphere (e.g., nitrogen) to form the carbon aerogel. More specifically, the polymerization reaction is a sol-gel polymerization of multifunctional organic monomers in a solvent (e.g., water). The sol-gel polymerization leads to the formation of highly cross-linked, transparent or translucent gels referred to hereinafter as “hydrogel sols”). A metal may also be added with the monomers, thereby forming an aerogel/metallic composite.

In a preferred sol-gel polymerization, one mole of resorcinol (1,3-dihydroxybenzene) condenses in the presence of a basic catalyst with two moles of formaldehyde. A mildly basic catalyst (e.g., sodium carbonate) is preferred. Resorcinol is a trifunctional monomer capable of receiving formaldehyde molecules in the 2-, 4-, and/or 6-positions on its ring. The substituted resorcinol rings condense with each other to form nanometer-sized clusters in solution. Eventually, the clusters crosslink through their surface groups (e.g., —CH₂OH) to form the hydrogel sol.

The size of the clusters can be regulated by the concentration of catalyst in the resorcinol-formaldehyde (RF) mixture. More specifically, the mole ratio of resorcinol (R) to catalyst (C) (R/C) controls the surface area and electrochemical properties of the resulting gel. Preferably, the R/C ratio is about 50 to about 300. Other commonly referenced ratios include resorcinol (R) to formaldehyde (F) (R/F) and resorcinol (R) to water (W) (R/W). Typically, the R/F and R/W molar ratios are each about 0.01 to about 10.

The hydrogel sol is then cured for a time and temperature sufficient to stabilize the aerogel structure and form a cured hydrogel. Curing times range from about 2 hours to about 5 days or more. Curing temperatures range from about 25 degrees centigrade (C) to about 150 degrees C. Pressures greater than 1 atmosphere (atm) can be used to decrease the curing time. After curing, RF aerogels may be translucent and dark red or black in color or substantially transparent.

The next step in organic aerogel preparation is to dry the cured hydrogel. If the polymerization solvent is removed from the gel by simple evaporation, large capillary forces are exerted on the pores, thereby forming a collapsed structure, i.e., a xerogel. In order to preserve the gel skeleton and minimize shrinkage, it is preferable to perform the drying step under supercritical conditions (described hereinafter). Other drying steps may also be conducted, if desired, usually before the supercritical extraction step. For example a solvent exchange may be conducted in which the cured hydrogel is contacted with an exchange solvent, e.g., acetone, prior to subjecting the cured hydrogel to supercritical extraction to form the dried aerogel. The supercritical extraction may be performed with a supercritical fluid, such as liquid carbon dioxide. Also, as an alternative or in addition to the exchange step, surfactants may be used to remove water from the cured hydrogel. The highly porous material obtained from this removal operation is the organic aerogel. By appropriate adjustment of drying conditions, a hybrid structure having characteristics of both a xerogel and an aerogel may be produced. For example, such a hybrid may be produced as a result of a partial evaporation of the gel solvent under conditions promoting xerogel formation followed by evaporation of the remaining solvent under conditions promoting aerogel formation. The resulting hybrid structure would then be dried under supercritical conditions and pyrolized. Preparation of other xerogel-aerogel hybrids may be produced by first evaporating under conditions promoting aerogel formation and completing the evaporation under xerogel-promoting conditions.

As noted above, one means for removing water from the cured hydrogel is by extraction under supercritical conditions. As used herein, a “supercritical fluid” (also referred to in the art as “supercritical solution” or “supercritical solvent” is one in which the temperature and pressure of the fluid are greater than the respective critical temperature and pressure of the fluid. A supercritical condition for a particular fluid refers to a condition in which the temperature and pressure are both respectively greater than the critical temperature and critical pressure of the particular fluid.

A “near-supercritical fluid” is one in which the reduced temperature (actual temperature measured in Kelvin divided by the critical temperature of the solution (or solvent) measured in Kelvin) and reduced pressure (actual pressure divided by critical pressure of the fluid) of the fluid are both greater than 0.8 but the fluid is not a supercritical fluid. A near-supercritical condition for a particular fluid refers to a condition in which the reduced temperature and reduced pressure are both respectively greater 0.8 but the condition is not supercritical. Under ambient conditions, the fluid can be a gas or a liquid. The term fluid is also meant to include a mixture of two or more different individual fluid. As used herein, the term “supercritical fluid” and “supercritical conditions” are intended to include near-supercritical fluids and near-supercritical conditions respectively.

The temperature and pressure of the extraction process depend on the choice of supercritical fluid. Generally, the temperature is less than about 250 degrees C. and often less than 100 degrees C., while the pressure is about 50 atm to about 500 atm.

Solvents that can be used as supercritical fluids are sometimes referred to as dense gases. Suitable solvents for use as supercritical fluids include, for example, carbon dioxide, ethane, propane, butane, pentane, dimethyl ether, ethanol, water and mixtures thereof. Carbon dioxide is a preferred supercritical fluid for use in accordance with the present invention. For example, at 333 Kelvin (K) and 150 atm, the density Of CO₂ is 0.60 grams per cubic centimeter (g/cm³); therefore, with respect to CO₂, the reduced temperature is 1.09, the reduced pressure is 2.06, and the reduced density is 1.28. Carbon dioxide is a particularly good choice of supercritical fluid. Its critical temperature (31.1 degrees C.) is close to ambient temperature and thus allows the use of moderate process temperatures (less than about 80 degrees C.). The time required for supercritical drying depends on the thickness of the gel.

In cases where the cured hydrogels are of sufficiently high density, such as greater than about 40 weight percent (wt %) solids, the pore network may have sufficient inherent strength to withstand the drying process without resort to supercritical drying conditions. Thus, carbon dioxide may be bled from the vessel under non-supercritical conditions. Non-supercritical drying is particularly attractive because of its reduced processing time. To maximize crosslinking and further increase the density of the gels, the cured hydrogel may be subjected to a cure cycle.

Following the solvent exchange/extraction step and any cure cycle, the organic aerogel may be pyrolized at elevated temperatures of about 400 degrees C. to about 2,000 degrees C. in an inert atmosphere of nitrogen, argon, neon, helium, or any combination of the foregoing gases to form a pyrolized aerogel, e.g., a carbon aerogel. The pyrolysis temperatures can alter the surface area and structure of the pyrolized aerogel. In particular, higher surface areas are achieved at lower temperatures. The resulting aerogels, independent of the procedure by which they are pyrolized, are black and not transparent due to the visible absorption properties of the carbon matrix.

The aerogels of the present invention typically have a surface area of from about 400 to about 2,000 square meters per gram (“m²/g”), a pore volume of about 0.5 cubic centimeters per gram (“cm³/g”) to about 10 cm³/g, and a density of about 0.01 g/cm³ to about 2.0 g/cm³. Such properties can be readily determined by those skilled in the art. For example, surface area and pore volume can be determined by the BET method (the Brunauer, Emmett, and Teller method), and density can be determined by using a pycnometer.

In embodiments in which a metal is added to form a metallic aerogel composition, the amount of the aerogel present is about 20 wt. % to about 99.9 wt. %, preferably about 40 wt. % to about 99 wt %, and more preferably about 50 wt. % to about 90 wt. %, based on the total weight of the composition, i.e., total solids (metallic particle plus aerogel exclusive of any liquids). The amount of the metallic particle in the metallic aerogel compositions of the present invention is about 0.1 wt. % to about 80 wt. %, preferably about 1 wt. % to about 60 wt. %, and more preferably about 10 wt. % to about 50 wt. %, based on the total weight of the composition.

In embodiments in which the metallic carbon aerogel composition is used as fuel cell catalyst, metallic particles are preferably in the crystal form of free metal, i.e., zero valence, and not ionic, e.g., not in the form of a metallic compound, but may be in the form of alloy crystal of different metal atoms. Examples of suitable metals include iron, cobalt, magnesium, nickel, titanium, chromium, copper, platinum, gold, silver, rhodium, ruthenium, palladium, iridium, and the like, as well as combinations thereof. Preferred metals include platinum, rhodium, palladium, iridium, silver, gold, and combinations thereof. Preferred metals for use in aerogels utilized with DM fuel cells include, but are not limited to, alloys and mixtures of platinum and ruthenium.

Preferably, the metallic compound (precursor) is provided in the form of an organometallic compound, which comprises a transition metal bound to one or more organic ligands. Some examples of useful organometallic compounds include the following classes of ligands: beta-diketonates (e.g., Cu(hfaC)₂ or Pd(hfac)₂, where “hfac” is an abbreviation for 1,1,1,5,5,5-hexafluoroacetylacetonate), alkyls (e.g., Zn(ethyl)₂ or dimethyl(cyclooctadiene)platinum(II) (CODPtMe₂)), allyls (e.g. bis(allyl)zinc, or W(π⁴-allyl)₄), dienes (e.g., CODPtMe₂), or metallocenes (e.g., Ti(π⁵-C₅H₅)₂ or Ni(π⁵-C₅H₅)₂). Preferred organometallic compounds include dimethyl(cyclooctadiene)platinum(II), tetraamine platinum (II) chloride, platinum(II)hexafluoroacetylacetone, (trimethyl)methylcyclopentadienylplatinum(IV), bis(cyclopentadienyl)ruthenium, bis(ethylcyclopentadienyl)ruthenium(II), bis(pentamethylcyclodienyl)ruthenium, (methylcyclopentadienyl)(1,5-cyclooctadiene)iridium(I), and mixtures thereof.

In accordance with the present invention, the metallic particles have an average particle size of about 4 nanometers (nm) or less, based on the number of metallic particles. Preferably, the average particle size of the metallic particles is about 3 nm or less, more preferably about 1 nm to about 2 nm, and even more preferably about 1 nm. As used herein, the term “average particle size” is intended to indicate the average diameter (also referred to in the art as “effective diameter”). A preferred technique for measuring the average particle size is to measure the diameter of a representative number of particles from an electron micrograph, e.g., from a transmission electron microscope (“TEM”) and calculate an average. Another method is hydrogen or CO chemisorption where the total metal surface area is measured. This information can then be used to calculate the average particle diameter.

Preferably, the metallic compound is deposited in the substantial absence of a reaction reagent (of the metallic compound). Preferably, the supercritical fluid containing the metallic compound comprises less than about 5 wt. %, more preferably less than about 1 wt. %, and most preferably less than about 0.1 wt. % of a reaction reagent, based on the total weight of the supercritical fluid, reaction reagent and metallic compound. Preferably, there is no chemical change to the metallic compound during the supercritical deposition of the metallic compound onto the aerogel surface.

The aerogel compositions can have a very narrow particle size distribution of the metallic particles. For example, when the metallic particles have an average particle size of about 4 nm or less, less than about 20% of the metallic particles have a particle size of about 5 nm or greater, based on the number of metallic particles. When the metallic particles have an average particle size of about 3 nm, less than about 20% of the metallic particles have a particle size of about 4 nm or greater and less than about 20% of the metallic particles have a particle size of about 2 nm or less. When the metallic particles have an average particle size of about 2 nm, less than about 20% of the metallic particles have a particle size of about 3 nm or greater and less than about 20% of the metallic particles have a particle size of about 1 nm or less. Preferably, less than about 20% of the metallic particles have a particle size of about 3 nm or greater and less than about 20% of the particles have a particle size of less than about 1 nm. More preferably, when the metallic particles have an average particle size of about 1 nm, less than about 20% of the metallic particles have a particle size of about 2 nm or greater and less than about 20% of the metallic particles have a particle size of less than about 1 nm, based on the number of metallic particles. The particle size distribution can readily be determined by generating a histogram of the particle sizes from the TEM micrographs described above.

In one aspect of making a metallic aerogel composition, the manufacturing process comprises contacting an aerogel with a supercritical fluid comprising a metallic compound. The concentration of the metallic compound should be sufficient to provide the desired amount of the metallic particle dispersed within the aerogel.

In another aspect of making a metallic aerogel composition, the metallic compound can be added along with the reactants, e.g., monomers, in the preparation of the hydrogel sol. This can be conducted in addition to, or instead of, the contacting of the aerogel with a supercritical fluid comprising a metallic compound. In still yet another aspect of making a metallic aerogel composition, the metallic particle can be impregnated into the surface of the aerogel.

The metallic aerogel compositions can be used with the metal present in an ionic state or in the free metal state. If the free metal state is desired, the metal in ionic form can be reduced by any method known to those skilled in the art, e.g., by conducting a second themolysis step, e.g., at a temperature of about 200 degrees C. to about 600 degrees C., or by contacting the metallic aerogel composition with a reduction gas such as, for example, hydrogen, to form a reduced metal aerogel. Preferably, the metallic particles have a surface area of at least about 50 m²/g, preferably at least about 100 m²/g, more preferably at least about 200 m²/g, and most preferably at least about 300 m²/g.

In one preferred aspect of the invention, there is provided a process for making a metallic aerogel composition comprising polymerizing at least two monomers in a liquid medium to form a polymerization product comprising a hydrogel sol and the liquid medium, curing the hydrogel sol to form a cured hydrogel, removing at least a portion of the liquid medium from the cured hydrogel to form an organic aerogel, pyrolizing the organic aerogel to form a pyrolized aerogel, and contacting the pyrolized aerogel with a supercritical fluid comprising a metallic compound to form a metallic aerogel.

In another preferred aspect of the invention, there is provided a process for making a metallic aerogel composition comprising polymerizing at least two monomers in a liquid medium to form a polymerization product comprising a hydrogel sol and the liquid medium, curing the hydrogel sol to form a cured hydrogel, optionally removing at least a portion of the liquid medium from the cured hydrogel to form a dried aerogel, contacting the dried aerogel or the cured aerogel with a fast supercritical fluid to form an organic aerogel, pyrolizing the organic aerogel to form a pyrolized aerogel, and optionally contacting the pyrolized aerogel with a second supercritical fluid to form a metallic aerogel. At least one of the first supercritical fluid and the second supercritical fluid comprises a metallic compound.

Thus, in accordance with this aspect of the present invention, either the first supercritical fluid or the second supercritical fluid, or both, comprises the metallic compound.

The processes of the present invention may comprise further steps as desired. For example, a preferred aspect of the invention further comprises the step of contacting the metallic aerogel with a polymer electrolyte, e.g, a perfluorosulfonated ionomer (e.g., Nafion®, available from E. I. duPont de Nemours and Company, Wilmington, Del.) as a 5% solution of perfluorosulfonic acid/PTFE copolymer in the (H+) form. Preferably, the contacting is conducted after incorporation of the metallic particles into the aerogel.

Particular forms of the aerogel compositions include powders, particles, extrudates, pellets, films, coatings, fibers, and the like. Likewise, the compositions of the present invention can have a variety of end uses such as, for example, use in fuel cell electrodes, as electrode catalysts, use as catalysts for chemical reactions, e.g., hydrogenation or dehydrogenation, oxidation, isomerization, reforming, hydrocracking, polymerization, etc. Use of the compositions of the present invention as fuel cell electrode catalyst, e.g., PEM electrodes catalyst, is especially preferred, as is described below.

In this embodiment, particular forms of the aerogel composition include carbon aerogel supported platinum electrocatalyst paste, slurry, or ink where the powder is reduced in size and is homogenized with polymer electrolyte.

One exemplification of producing platinum loaded carbon aerogels includes placing a platinum precursor (for example, Pt(NH₃)₄(Cl₂)) into a solution together with resorcinol, formaldehyde, and sodium carbonate. Resorcinol and formaldehyde polymerize and are thereafter cured. Water is then extracted from the matrix using acetone. Subsequent supercritical carbon dioxide extraction of acetone results in a platinum complex uniformly distributed in an organic resorcinol-formaldehyde (RF) aerogel matrix. The matrix is subsequently subjected to pyrolysis under a nitrogen atmosphere resulting in a carbon aerogel loaded with platinum metal.

The curing time of the RF aerogels can be decreased by carrying out the curing at a temperature of about 50 degrees C. to about 200 degrees C., preferably about 70 degrees C. to about 200 degrees C., and more preferably about 90 degrees C. to about 140 degrees C., by conducting the process, for example, in glass lined steel vessels under pressure greater than about 1 atm, e.g., about 1 atm to about 5 atm. Moreover, surfactants may be used to remove the water directly from RF aerogels without the need for acetone exchange.

Another exemplification of the present invention for producing platinum loaded carbon aerogels includes contacting an RF aerogel sample with a super critical CO₂ solution containing a platinum precursor (for example, CODPt(CH₃)₂) dissolved therein. The platinum precursor is adsorbed onto the aerogel. Hydrogen is then used to reduce the platinum precursor to platinum metal. The RF aerogel is then depressurized and subjected to pyrolysis resulting in a carbon aerogel loaded with platinum metal.

In this exemplification, instead of using hydrogen to reduce the platinum precursor to a platinum metal, the RF aerogel may be depressurized and then subjected to pyrolysis under a nitrogen atmosphere. The platinum metal results due to the thermal reduction of the platinum precursor.

Another exemplification of the present invention includes impregnating a carbon aerogel with a platinum precursor (for example, CODPtMe₂). The platinum precursor is converted to a finely dispersed platinum metal within the aerogel matrix by pyrolizing under a nitrogen atmosphere. The atmosphere can also be a mixture of hydrogen with any inert gas.

Another exemplification of the present invention includes a silica aerogel impregnated with an organometallic complex containing platinum (Pt) using supercritical carbon dioxide (scCO₂) as the solvent medium.

Preparation conditions such as reactant (monomer) concentrations, curing times and temperatures, impregnation conditions, pyrolysis temperatures, and pressures can all be changed appropriately to control the properties of the resulting materials. For example, it was realized that platinum loaded RF aerogels prepared using the method according to the second exemplification turned black while degassing at 200 degrees C. This indicated that platinum was acting as a catalyst in the pyrolysis. Therefore, substantially lower pyrolysis temperatures may be employed in order to facilitate the incorporation of the aerogels into other materials such as Nafion® which often do not survive the usual high pyrolysis temperatures.

An exemplification of a utility of the present invention is that the carbon aerogels, and particularly although not exclusively those derived from RF aerogels, may be utilized as gas diffusion electrodes or catalyst layers in the structure of a either a PEM fuel cell or a DM fuel cell.

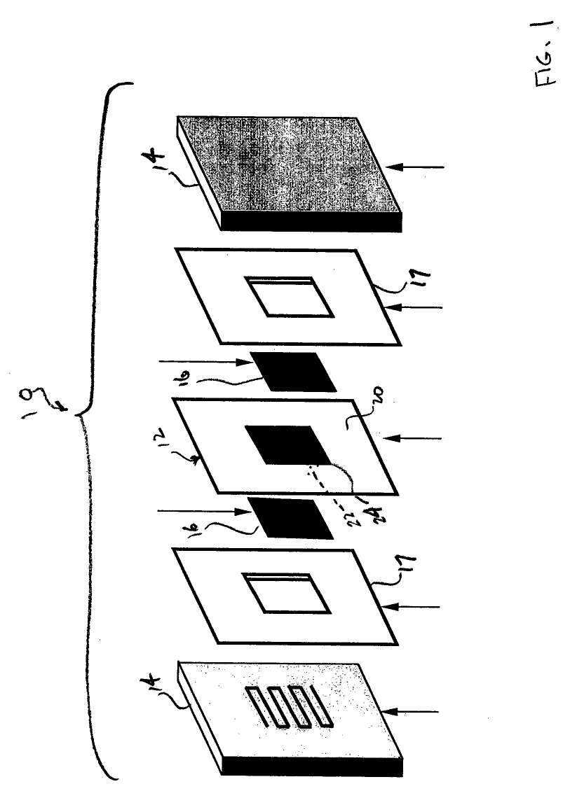

In this exemplification, referring to FIG. 1, a fuel cell is shown generally at 10. The fuel cell 10 comprises an MEA 12 mounted between flow plates 14, each of which may be configured to provide for the flow of fluid to and from the MEA 12. The MEA 12 comprises a solid electrolyte membrane such as a proton-conducting substrate 20 on which is disposed an anode catalyst layer 22 and a cathode catalyst layer 24. Diffusion media 16 (e.g., conductive carbon paper) are mounted intermediate the MEA 12 and the facing surfaces of each flow plate 14, thereby facilitating fluid communication of the hydrogen gas between the flow channel and the anode catalyst layer, and further facilitating fluid communication of the reactant oxygen gas and the resultant water vapor between the cathode flow channel and the cathode catalyst layer. Sealing gaskets 17 (e.g., polytetrafluoroethylene masks) may be mounted intermediate the MEA 12 and each flow plate 14.

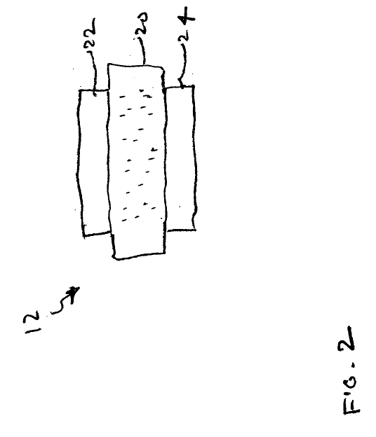

In this exemplification, referring now to FIG. 2, the MEA 12 is shown in detail. As is stated above, the MEA 12 comprises the proton-conducting substrate 20 on which the carbon supported catalyst is deposited to form the anode catalyst layer 22 and the cathode catalyst layer 24.

In this exemplification, the carbon supported catalyst comprises carbon aerogel supported platinum or other catalytic metals. The proton-conducting substrate 20 is preferably a polymeric substrate having a particular degree of ionic conductivity sufficient to facilitate the proton communication therethrough. Preferred polymers for the polymeric substrates are perfluorosulfonate ionomers (e.g., Nafion®).

In this exemplification, the carbon supported catalyst preferably comprises a carbon aerogel as described above having platinum or other catalytic metals in alloy or pure crystal dispersed therein. The pore size of a carbon aerogel utilized as a catalyst support is regulated during its synthesis by the amounts and ratios of reactants and catalyst as well as the reaction conditions. Preferably, the amounts and ratios of reactants and the reaction conditions are regulated to result in a mesoporous aerogel having a surface area of greater than about 400 m²/g and preferably more than about 600 m²/g. The term “mesoporous” is intended to indicate a pore size of about 2 nm to about 50 nm. Preferred pore sizes are greater than about 4 nm and more preferably greater than about 15 nm for both the cathode catalyst layer and the anode catalyst layer.

Also in this embodiment, the catalyst is preferably platinum crystals or other metal crystals or alloy thereof formed by the impregnation of such metallic precursor onto the carbon aerogel support in the presence of carbon dioxide at supercritical conditions. The amount of metal dispersed onto the support is controlled by the addition of a preselected amount of metal precursor to a vessel in which the dispersion occurs. The dispersion rate, which is calculated by the ratio of catalytically active atoms to the total catalyst atoms dispersed in the catalyst, is about 35%, preferably about 50%, more preferably about 70%, and even more preferably about 90%. The platinum or other metal used has a chemically active surface area that is greater than about 80 m²/g, preferably greater than 100 m²/g, more preferably greater than 150 m²/g, even more preferably greater than about 200 m²/g, and even more preferably about 250 m2/g. The total amount of metal deposited may be limited by the equilibrium of adsorption and desorption of metal precursor onto the carbon aerogel in carbon dioxide at supercritical conditions. One exemplary condition under which the carbon dioxide may be deposited is a temperature of 80 degrees C. for 24 hours.

Also in this embodiment, the catalyst powder made of crushed carbon aerogel is homogenized with the unagglomerated polyfluorosulphone electrolyte (e.g. Nafion® 1100) solution and combined with a binder to make catalytic paste, slurry, or ink.

The catalyst powder (the platinum or other catalytic metal laden aerogel) are preferably deposited on the proton-conducting substrate 20 as catalyst paste, slurry, or ink. Methods by which catalyst paste, slurry, or ink may be deposited on the substrate include, but are not limited to, printing, pasting, spraying, dipping, and the like. The thickness to which the catalyst paste, slurry, or ink is deposited is less than about 100 micrometers (um), preferably less than about 20 um, and more preferably less than about 10 um

The invention is hereafter described with respect to the following examples, which are not intended to limit the scope of the claims.

Synthesis of RF Organic Aerogels

### EXAMPLE 1A

The RF aerogels were synthesized by the reaction of resorcinol with formaldehyde. For each run, 2 grams (g) of resorcinol was dissolved in 2.38 g of water in a test tube. Subsequently, 0.019 g of sodium carbonate and 2.95 g of formaldehyde solution were added.

The tube was then sealed with a rubber stopper and the contents mixed by shaking. The tube was kept at room temperature for one day, at 50 degrees C. for one day, and at 90 degrees C. for three days. At the end of the first day, the solution in the tube gelled and was yellow-orange in color. The gel progressively darkened during the curing period (at 50 degrees C. and 90 degrees C.) and was dark red-black at the end of the three-day period at 90 degrees C. At the end of the 90 degrees C. period, the resulting monolith was taken out of the test tube and immersed in approximately 200 milliliters (ml) of acetone and kept in the acetone for two days. The acetone was then extracted supercritically. Supercritical carbon dioxide extraction was conducted using a high-pressure vessel having an internal volume of 54 cubic centimeters (cm³). The vessel was custom manufactured from 316 stainless steel and equipped with two sapphire windows each having a diameter of about 1.25 inches (in.) and a thickness of about 0.5 in. The windows were sealed on both sides with poly ether ether ketone) (PEEK) seals.

Supercritical carbon dioxide extraction was conducted using a high-pressure vessel having an internal volume of 54 cubic centimeters (cm³). The vessel was custom manufactured from 316 stainless steel and equipped with two sapphire windows each having a diameter of about 1.25 inches (in.) and a thickness of about 0.5 in. The windows were sealed on both sides with poly(ether ether ketone) (PEEK) seals.

The vessel was filled with acetone and the monolith was placed in the vessel. The vessel was charged very slowly with CO₂ from a syringe pump (ISCO, Lincoln, Nebr., Model 260D). The vessel was connected to a back pressure regulator that kept the system pressure at 200 bars. The acetone was displaced by liquid CO₂ as evidenced by the transformation from a two-phase—to a single-phase system. The vessel was then heated to the desired temperature (50 degrees C.) by a recirculating heater/cooler (Fisher) via a machined internal coil.

Extraction was continued for a period of about 4 hours until no acetone could be detected in the effluent stream. This process consumed approximately 400 g of CO₂. The temperature was controlled during each experiment with a variation of 0.5 centigrade degrees. The pressure was measured using a pressure transducer (Omega Engineering, Stamford, Conn., Model PXOIKI-5KGV). At the end of the extraction period, the vessel was slowly depressurized at 50 degrees C. Depressurization took approximately 3 hours.

Once the depressurization was complete, the vessel was opened and the monolith removed as RF aerogel. The weight of the monolith was 2.9 g (theoretical yield 3.09 g) indicating that almost all of the resorcinol and formaldehyde polymerized and very little weight loss occurred during processing. The shape and volume of the monolith was preserved during the extraction and depressurization process.

The properties of the RIF aerogel were investigated by BET nitrogen adsorption. Part of the aerogel was crushed into a powder and analyzed, and part was broken down into large pieces and one of the pieces analyzed. The BET surface area (SA) and pore size distribution of RF and carbon aerogels were obtained from at least ninety (90) point nitrogen adsorption/desorption analysis with a Micromeritics ASAP 2010 instrument. All samples were outgassed at 100 degrees C. (for RF) and 200 degrees C (for carbon aerogels) prior to any adsorption-desorption measurements. BET SA was calculated from the linear part of the BET equation over the relative pressure range (ratio of pressure to saturation pressure) of 0.03 to 0.30. Pore size distributions were derived from the incorporated software of the instrument using the Barrett, Joyner and Halenda (“BJH”) method.

Powder Form:

| | |
|---|---|
| BET Surface Area: | 888 m²/g |
| Pore Volume: | 1.24 cm³/g |
| Average Pore Diameter: | 5.5 nm (from BJH desorption) |

Large Piece Form:

| | |
|---|---|
| BET Surface Area: | 873 m²/g |
| Pore Volume: | 1.49 cm³/g |
| Average Pore Diameter: | 6.3 nm (from BJH desorption) |

The data indicate that the pore structure stayed substantially intact when crushed. There seemed to be a slight decrease in the pore volume and average pore diameter upon crushing. The shapes of hysteresis loops for both crushed and uncrushed samples are Type E.

### EXAMPLE 1B

In another procedure, RF aerogels were again synthesized by the reaction of resorcinol with formaldehyde. For each run, 7.76 g of resorcinol was dissolved in a sodium carbonate solution (37 milligrams (mg) of sodium carbonate in 89.05 g of de-ionized water). Subsequently, 11.45 g of formaldehyde was added into the solution. The solution was then sealed in a glass vessel and kept one day at room temperature, one day at 50 degrees C. in an oven, and three days at 87 degrees C. in an oven. At the end of the first day (at room temperature), the solution gelled and had a yellow-orange color. The gel progressively became darker during the curing period in the oven and ultimately achieved a dark red color. At the end of the three day 87 degrees C. period, the resulting gelled monolith was taken out and immersed in acetone for 5 days. Each day the old acetone was replaced with fresh acetone.

Acetone in the aerogel was supercritically extracted from the monolith with carbon dioxide by using a modified ISCO supercritical fluid extractor (SFX 220, internal volume of 2×50 cm³). The monolith was placed in an extraction chamber, and the chamber was filled with acetone. The chamber was then heated to 46 degrees C. Subsequently, an extraction program (i.e., a specification of the pressure and amount of CO₂ used for extraction) was set up to be 6 liters of CO₂ at 3000 psi. At the end of the extraction, the chamber was slowly depressurized at 46 degrees C. Once the depressurization was complete, the chamber was opened and the monolith removed as RF aerogel. Its weight and dimensions were recorded.

Acetone-Water Exchange

### EXAMPLE 2

To investigate the effect of immersion time in acetone, 3 monoliths were prepared using the procedure and reactant compositions given above in Example 1A. One sample was left for 1 day, one sample was left for 2 days, and one sample was left for 5 days in an acetone bath followed by a one hour sonication in fresh acetone. Subsequently, acetone was extracted from the samples using supercritial carbon dioxide. The monoliths were placed in the extraction chambers, and the chambers were heated to 46 degrees C. At the end of the heating period, an extraction program of 6 liters of CO₂ at 3,000 psi was set up to conduct the extraction.

At the end of the extraction, the chambers were slowly depressurized at 46 degrees C. After depressurization, the weights of the pellets ranged from 2.84 g to 2.90 g indicating that immersion time in acetone had no effect on the amount of water displaced. It is believed that sonication of the samples in acetone accelerated the acetone-water exchange process dramatically.

Synthesis of Carbon Aerogel

### EXAMPLE 3A

Resorcinol-formaldehyde aerogels made in accordance with Example 1A were converted to carbon aerogels by pyrolysis in an inert nitrogen atmosphere. An RF aerogel in monolithic form was placed in a quartz tube. The quartz tube was paced in a tubular oven. One end of the tube was connected to a nitrogen cylinder.

The flow rate of the nitrogen into the tube was controlled using a needle valve placed after the regulator. The other end of the tube was connected to a soap bubble meter to measure the flow rate of nitrogen. The flow rate of nitrogen was adjusted to 100 cubic centimeters per minute (cm3/min.), and the oven was heated to 1,000 degrees C. under flowing nitrogen. The heating rate was approximately 5 centigrade degrees per minute. The temperature inside the oven reached 1,020 degrees C. in approximately 6 hours.

The oven was kept at this temperature for another 5 hours. Subsequently, the oven was turned off and cooled overnight with nitrogen flowing. The material removed from the tube was black and its size appeared to have shrunk compared to the original material.

Large Piece Form:

| | |
|---|---|
| BET Surface Area: | 741 m²/g |
| Pore Volume: | 0.77 cm³/g |
| Average Pore Diameter: | 3.4 nm (from BJH desorption) |

The analysis indicates that loss of surface area was not significant during pyrolysis. However, the pore volume decreased and the average pore diameter also decreased in accordance with the volume contraction observed.

### EXAMPLE 3B

A carbon aerogel was synthesized by the pyrolysis of an RF aerogel in a tube furnace (Mellen, MT13-3X12-1Z) under an inert nitrogen atmosphere. The RF aerogel was placed in a pure alumina tube, which was placed in the furnace. One end of the tube was connected to a nitrogen cylinder and the other end was connected to the outlet of a fume hood. Nitrogen was flowed into the tube at 100 ml/min. and monitored using a flowmeter. The pyrolysis temperature profile was edited to process the pyrolysis. Specifically, the carbon aerogel was heated in the furnace at a rate of approximately 15 centigrade degrees per minute to result in a final temperature of 1,000 degrees C., and the temperature of the furnace was maintained at 1,000 degrees C. for an additional six hours. The tube furnace was then cooled to room temperature with flowing nitrogen at a rate of 100 ml/min. The material removed as carbon aerogel from the tube was black in color, and its weight and dimensions were recorded.

Effect of Reactant Concentrations on the Properties of Aerogels

### EXAMPLES 4-11

To investigate the effects of concentrations of the reactants and catalyst on the properties of the aerogels, a variety of solutions were prepared and processed as explained above.

The characteristics of the aerogels are shown in Table 1.

TABLE 1
Effect of Reactant Composition on Properties of Aerogels

| | | | | Average Pore | | |
|---|---|---|---|---|---|---|
| | | | BET SA | Diameter nm | | Pore Volume |
| Example No. | R/C | R/W | m²/g | BET | BJH | cm³/g |
| 4-C₁₂RF | 99.1 | 0.08 | 888.6 | 5.6 | 5.5 | 1.24 |
| 5-C₁₂CA | 99.1 | 0.08 | 741.2 | 4.1 | 4.3 | 0.78 |
| 6-C₁₃RF | 50.0 | 0.08 | 864.0 | 5.3 | 4.5 | 1.1 |
| 7-C₁₃CA | 50.0 | 0.08 | 682.4 | 3.1 | 3.2 | 0.52 |
| 8-C₁₁RF | 91.2 | 0.04 | 765.4 | 11.0 | 9.9 | 2.10 |
| 9-C₁₁CA | 91.2 | 0.04 | 723.4 | 8.6 | 7.9 | 1.55 |
| 10-C₄₉RF | 200.0 | 0.02 | 636.7 | 19.3 | 20.7 | 3.03 |
| 11-C₄₉CA | 200.0 | 0.02 | 629.2 | 16.5 | 17.1 | 2.63 |

Deposition of Platinum on Aerogel

### EXAMPLE 12A

RF aerogels were impregnated with an organometallic complex containing platinum which was subsequently reduced to platinum metal and carbon aerogel by pyrolysis.

Two monoliths of RF aerogels each weighing 0.8 g were placed in the vessel described above in Example 1A together with 0.150 g of finely ground dimethyl(cyclooctadiene)platinum (II) (CODPtMe2). The vessel was heated to 80 degrees C. and charged with carbon dioxide to 2,250 psig. The system was depressurized after 6 hours. The weight of each monolith was determined to be 0.85 g indicating that 50 milligrams of the Pt complex had adsorbed on the RF aerogel. The RF aerogel pieces were pyrolized as described in Example 3A resulting in 0.42 g of platinum loaded carbon aerogel. The estimated platinum content was 7 wt. %.

The sample was also characterized for its platinum content based on method EPA 3010. The sample was first digested with nitric acid and hydrochloric acid. Subsequently, the samples were put in a hot block for about 4 hours and then the solution was analyzed by Inductively Coupled Mass Spectrometry (Perkin Elmer, Norwalk, Conn., Model OPTIMA 3300 XL, with AS 91 Autosampler, based on EPA Method 6010B). The sample had a platinum content of 5.6 wt. %, which is close to the gravimetrically-calculated value.

### EXAMPLE 12B

The platinum was first supercritically deposited onto the carbon aerogel in the form of a platinum precursor, dimethyl(cyclooctadiene)platinum (II) using supercritical deposition. For 5 wt. % Pt catalyst, 10.78 g of carbon aerogel and 1.07 g of platinum precursor were placed in the vessel together with a stir bar. The vessel was sealed and placed on a magnetic stirrer. A selected amount of carbon dioxide was charged to vessel using a syringe pump (ISCO, 260D). The vessel was then heated to 80 degrees C. and adjusted carbon dioxide to 4,000 psig. The conditions were maintained for 24 hours with stirring. The temperature of the vessel was then reduced to 60 degrees C. and carbon dioxide was vented out. The carbon aerogel supported platinum catalyst precursor weighed 11.8 g. The actual deposition amount was determined based on the weight difference before and after deposition.

The formed carbon aerogel supported catalyst precursor was subsequently placed in a furnace tube. One end of the tube was connected to a nitrogen cylinder and the other end was the outlet to the fume hood. The flowrate of the nitrogen was controlled using a flowmeter, which was adjusted to 100 ml/min. The temperature profile was edited to process the reduction. Specifically, the heating rate was approximately 6 centigrade degrees per minute, and the final temperature was 220 degrees C. The furnace was kept at this temperature for another 15 minutes. The oven was then cooled to room temperature with flowing nitrogen. The material was removed from the tube as carbon aerogel supported platinum catalysts, which was 11.541 g.

For 20 wt. % Pt catalyst, the deposition procedure was the same as that described above, except the amount of carbon aerogel and platinum precursor. Carbon aerogel in the amount of 7.36 g as well as 3.46 g of platinum precursor were placed in the vessel and the deposited platinum content was found to be 20 wt. %. The reduction procedure was also the same as that described above. The final catalysts were found to weigh 9.547 g.

Metallic Compound Added to Sol

### EXAMPLE 13A

Two g of resorcinol were dissolved in 1.5 g of water in a test tube. To this solution, 0.019 g of sodium carbonate was added and the tube was shaken until clear solution was obtained. In a separate vial, 0.05 g of tetraamine platinum (II) chloride, Pt(NH₃)₄Cl₂ was dissolved in 1.18 g of water and the solution was added to the tube. The tube was sealed with a rubber stopper.

The tube was maintained at room temperature for 1 day, at 50 degrees C. for 1 day, and at 90 degrees C. for 3 days. At the end of the first day, the solution in the tube gelled and had a brownish color. After three days at 90 degrees C., the tube was taken out of the oven and cooled. The monolith was orange in color and there was no weight loss. The monolith was immersed in an acetone bath for two days. After sonication in fresh acetone for one hour, acetone was extracted by scCO2 as described above. The platinum loaded RF aerogel was pyrolyzed as described above in Example 3A yielding platinum-loaded carbon aerogel. The results of the BET analysis and hydrogen chernisorption studies are given below:

Powder Form:

| | |
|---|---|
| BET Surface Area: | 545 m²/g |
| Pore Volume: | 1.34 cm³/g |
| Average Pore Diameter: | 20.5 nm |

Hydrogen Chemisorption:

Metal Dispersion: 3.1 % based on the original amount of platinum placed into the sol

Metallic Surface Area: 0.79 m²/g sample

### EXAMPLE 13B

Two g of resorcinol were dissolved in 1.5 g of water in a test tube. To this solution, 0.019 g of sodium carbonate was added, and the tube was shaken until a clear solution was obtained. In a separate via, 0.05 g of potassium tetrachloroplatinate was dissolved in 1.18 g of water and the solution was added to the tube. The tube was sealed using a rubber stopper. The tube was kept at room temperature for 1 day, at 50 degrees C. for 1 day, and at 90 degrees C. for 3 days. At the end of the first day, the solution in the tube gelled and was brownish in color. After three days at 90′ C, the tube was taken out of the oven and cooled. The monolith had an orange color and there was no weight loss. The monolith was immersed in an acetone bath for two days. After sonication in fresh acetone for one hour, acetone was extracted by supercritical CO₂ as described above and the sample pyrolized.

Platinum Deposition on Aerogel with Carbon Dioxide

### EXAMPLE 14

A carbon aerogel prepared as described above in Example 3A was broken into small pieces, and 1.229 g of small pieces of the carbon aerogel, 250 mg of finely ground dimethyl(cyclooctadiene)platinum(II) (CODPtMe₂), and a magnetic stir bar were put into a 50 ml high pressure vessel equipped with a rupture disk assembly, sapphire windows and a pressure transducer. The vessel was placed on a magnetic stirrer and was heated to 800 degrees C. and charged with carbon dioxide to 4,000 psig. The vessel was maintained at these conditions for a period of 24 hours. After 24 hours, the vessel was depressurized and CODPtMe₂ loaded carbon aerogel was removed from the vessel. The carbon aerogel removed weighed 1.449 g indicating that 220 mg of the precursor was adsorbed into the carbon aerogel.

Reduction of Platinum

### EXAMPLE 15A

To illustrate the reduction of platinum, 593.2 mg of the CODPtMe₂ loaded carbon aerogel of Example 14 was placed in a quartz tube and heated to 350 degrees C. under flowing nitrogen in a furnace such as used for pyrolysis in Example 3A. It was kept at 350 degrees C. for a period of 6 hours. During this period, CODPtMe₂ was converted to platinum metal. The furnace was then turned off and the tube was allowed to cool under flowing nitrogen. The pieces of platinum loaded carbon aerogels were removed from the tube and crushed into particles. Analysis of the particles by TEM indicated the presence of uniformly distributed small platinum crystallites having an average size of 1 nm within the carbon aerogel matrix.

Additional samples were prepared in accordance with the procedures set forth in Examples 14 and 15A, the results of which are set forth in Table 2, below.

TABLE 2
Properties of Platinum Loaded Carbon Aerogel Particles

| | | | | Pt Loading Pt | |
|---|---|---|---|---|---|
| Sample | R/C | R/W | R/F | Size (nm) | wt. % |
| 15A(a)-C₆₉B | 100 | 0.08 | 0.5 | 13 | NA |
| 15A(b)-C₃₀ | 100 | 0.08 | 0.5 | 18 | 2 |
| 15A(c)-C₄₅ | 100 | 0.08 | 0.5 | 20 | 2 |
| 15A(d)-C₄₈ | 100 | 0.08 | 0.5 | 30 | 3 |
| 15A(e)-C₁₂ | 100 | 0.08 | 0.5 | 12 | 1 |
| 15A(f)-C₄₉ | 200 | 0.02 | 0.5 | 143 | NA |

The platinum particle size was determined using a Transmission Electron Microscope (TEM) (Model 2010, FAS JEOL).

### EXAMPLE 15B

In another Example illustrating the reduction of platinum, 614.1 mg of the CODPtMe₂ loaded carbon aerogel of Example 14 was placed in a quartz tube and heated to 500 degrees C. under flowing nitrogen in a furnace such as used for pyrolysis in Example 3A. The temperature of the furnace was maintained at 500 degrees C. for 6 hours. During this time, CODPtMe₂ was converted to platinum metal. The furnace was then turned off, and the tube was allowed to cool under flowing nitrogen. The platinum loaded carbon aerogel was removed from the tube and crushed into particles. Analysis of the particles by TEM indicated the presence of uniformly distributed small Pt crystallites having an average size of 1.2 nm within the carbon aerogel matrix.

Platinum Loading of a Silica Aerogel

### EXAMPLE 16

Random sizes of silica aerogels were purhcased from Marketech International, Inc., and the organic precursor, dimethyl(cyclooctadiene)platinum (II)(CODPtMe₂), from STREM Chemicals and was used without any purification. The silica aerogel had a whitish tint and was transparent.

A selected amount of this monolithic aerogel (842.5 mg) was placed in a high pressure vessel having an internal volume of 54 cm³. The vessel was custom manufactured from 316 stainless steel and equipped with two sapphire windows, each having a diameter of 1.25 in. and a thickness of 0.5 in., and each being sealed on both sides with PEEK seals. Platinum precursor finely ground and in the amount of 374.6 mg was also placed in the vessel.

The vessel was heated to 80 degrees C. and charged with carbon dioxide to 4,000 psig. In approximately 2.5 hours, all of the CODPtMe₂ dissolved and was adsorbed into the aerogel. The vessel was kept at these conditions for 24 hours to ensure that adsorption equilibrium was achieved. The system was depressurized slowly for 3 hours at 60 degrees C. and then cooled to room temperature. The sample was taken out of the vessel and weighed. The final weight was 1,059.3 mg which corresponds to a 216.8 mg loading of the precursor (approximately 20 wt. %). The aerogel composite was still intact and black in color but still vaguely transparent indicating some conversion of the precursor to platinum metal under these conditions.

An amount (804.4 mg) of this aerogel composite was placed in a quartz tube and then heated to 300 degrees C. using a Thermolyne Tube Furnace (Model F21125) with flowing nitrogen gas at 100 ml/min for 6 hours. The aerogel was cooled to room temperature and weighed. The final weight was 736.0 mg, which corresponds to 13% Pt loading, indicating the conversion of the precursor to the platinum metal was complete. The color of the composite was pitch black and color was uniform throughout. It was nontransparent but intact.

Preparation of Catalyst Ink and Membrane Electrode Assemblies

### EXAMPLE 17

Catalyst anode powder (Pt—Ru 53.5 % supported on carbon from Tanaka Inc.) were mixed under nitrogen with de-ionized water, 5% Nafion® 1100 solution and appropriate solvents. Prepared mixtures have been homogenized for few hours using Ultra-Terrux homogenizer with further evaporation of the excess amount of the solvent to obtain appropriate viscosity.

The cathode aerogel supported catalysts with different platinum loadings and pore size distributions were synthesized in the form of rods having diameters of 5 mm and ground in an agate mortar and then homogenized for 3 hours. After that, the catalyst paste slurry or ink preparation followed the procedure for the anode catalyst paste slurry or ink.

Polytetrafluoroethylene films used for decals were weighed before the application of the catalyst paste, slurry, or ink. Said paste, slurry, or ink was screen-printed using the Systematic Automation Model 810 Series Screen Printer, designed for the printing of different materials with utmost precision and ease.

The polyester screen from SAATI Print™ has been used for the deposition of ultrathin catalyst layers onto the surface of the polytetrafluoroethylene film. To form the MEA, the appropriate decals were placed on either side of Nafion® 117 or Nafion® 112 membranes purchased from DuPont. After drying and hot pressing at 70 kg/cm² for 5 min with either the Nafion® 117 or Nafion® 112 membrane, the polytetrafluoroethylene supported films were peeled off from the cathode and anode side of the MEAs.

Further experiments were provided in the ElectroChem Inc. hardware with 6.25 cm² active areas. Such experimentation included gas diffusion layers from SGL Technologies GmbH and polytetrafluoroethylene gaskets with a thickness 0.25 mm, which were compressed to 2 mm.

Characterization of Catalyst Ink and Membrane Electrode Assemblies

### EXAMPLE 18

In order to investigate the pore size effect on fuel cell performance, samples with different pore size were prepared as explained above. Table 3 shows how the reactant compositions affect the carbon aerogel pore size.

TABLE 3
Effect of reactant compositions on carbon aerogel pore size

| | | | | | Average |
|---|---|---|---|---|---|
| Sample No. | R/F | R/W | R/C | BET SA (m²/g) | Pore Diameter (nm) |
| 1 | 0.5 | 0.020 | 200 | 732 | 16 |
| 2 | 0.5 | 0.013 | 200 | 801 | 22 |

The carbon aerogels and carbon aerogel supported catalysts were characterized in terms of BET surface area, pore size distribution, chemical surface area, and the morphology of the catalyst.

The BET specific surface area and pore size distribution of RF aerogels and carbon aerogels were obtained from nitrogen adsorption/desorption analyses with a Sorptomatic 1990 instrument. For each analysis, a sample burette was outgassed and weighed, and a sample of a desired weight was placed into the sample burette. The sample was outgassed at a temperature of 300 degrees C. for one hour. The extract amount of sample was determined based on the weight difference of the empty outgassed sample burette and the sample burette containing outgassed sample. The BET surface area and pore size distribution were obtained using data processing software provided by ThermoQuest.

Effect of Reduction Conditions on Platinum Chemical Surface Area

### EXAMPLES 19-22

The chemisorption measurements were also carried out with a Sorptomatic 1990 instrument. The chemical surface area of carbon aerogel supported catalyst was determined by the standard hydrogen or carbon monoxide chemisorption measurements. Typically, the sample was pretreated with hydrogen at 300 degrees C. for 1 hour, and then degassed at 300 degrees C. for 1 hour. The extract amount of sample was determined based on the weight difference between the empty outgassed sample burette and the sample burette containing outgassed sample. Subsequently, the sample was subjected to chemisorption with either hydrogen or carbon monoxide. Table 4 below shows the effect of reduction on surface area.

TABLE 4
Effect of reduction conditions on specific chemical surface area

| | Samples No. | | | |
|---|---|---|---|---|
| | 19* | 20** | 21*** | 22**** |
| Specific Chemical | 107.34 | 92.38 | 145.62 | 251.04 |
| Surface area (m²/g Pt) | | | | |

*33 wt % Pt deposited in 16 nm CA, which was reduced at 300 degrees C. for 2 hrs.
**33 wt % Pt deposited in 16 nm CA, which was reduced at 300 degrees C. for 6 hrs.
***10 wt % Pt deposited in 22 nm CA, which was reduced at 230 degrees C. for 10 min under nitrogen flow.
****5 wt. % Pt deposited in 16 nm CA, which was reduced at 230 degrees C. for 30 minutes under nitrogen flow.

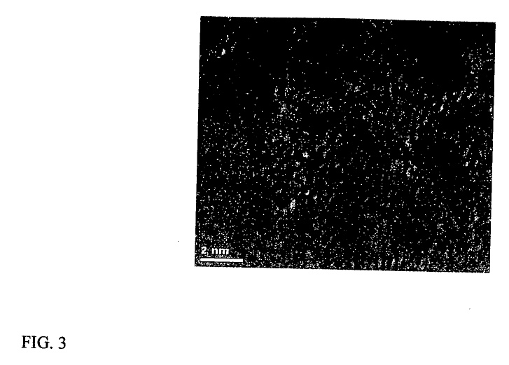

The morphology of catalyst was determined with transmission electron microscope (TEM) analysis (Model 2010, FAS JEOL). The samples for TEM were prepared by crushing gently with a mortar and pestle and were then suspended in a volatile solvent. A drop of the resulting suspension was deposited onto a holey-carbon coated TEM grid. FIG. 3 shows an HRTEM image of the catalyst paste, slurry, or ink of 33% Pt on 16 nm CA.

Effect of Catalyst Layer Thickness on Fuel Cell Performance

### EXAMPLE 23

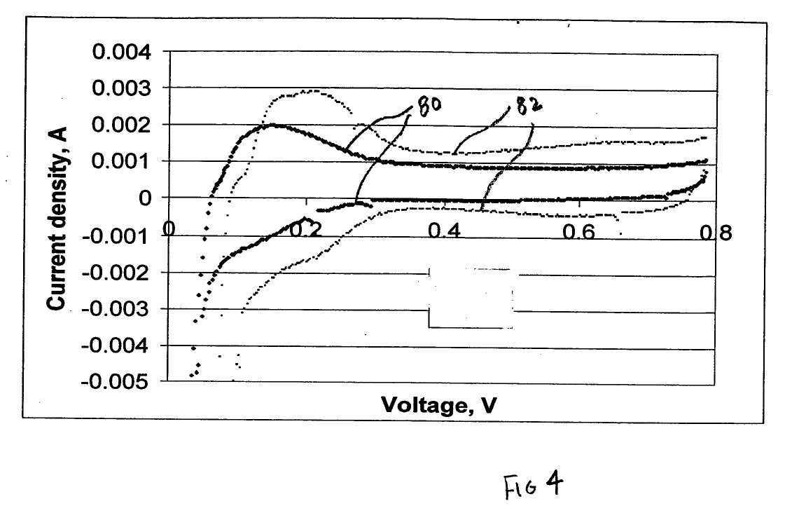

The electrochemical surface area available for the electrochemical reaction was determined using cyclic voltammetry (CV) technique in four-point probe configuration. The CV plots have been made in the range of 0.01-0.8 V and a scan rate of 20 mV/sec at room temperature using Princeton potentiostat Model 273. To avoid the presence of oxygen, and thus obtain correct data, extra-pure nitrogen was supplied to the cathode side as a working electrode and hydrogen to the anode as a counter electrode at 200 cc/min flow rate. Referring now to FIG. 4, cyclic voltammogram curves for 20 wt. % Pt on 22 nm CA are shown. In particular, cyclic voltammograms for a thin-film catalyst layer with a platinum loading of 0.1 mg/cm2 at a sweep rate of 25 millivolts per second is shown. The curve for day 1 is shown at lines 80, and the curve for day 7 is shown at lines 82. The calculated electrochemical surface area for line 82 is 90 m²/g Pt.

Fuel Cell Performance Testing

### EXAMPLE 24

The cell performance was evaluated using the Teledyne test station. The cell test station was equipped with the humidification chambers, mass flow and temperature controllers, and 50 Amp load box from Scribner, which allowed simultaneous correction of the cell potential for the iR-drop. All of the experiments were provided at 40, 60, and 80 degree C. temperature of the cell. In order to avoid condensing of water inside the cell, the line temperatures from the cathode and anode side were always 10 centigrade degrees higher than the cell temperature, which was equal to the temperature of both saturators.

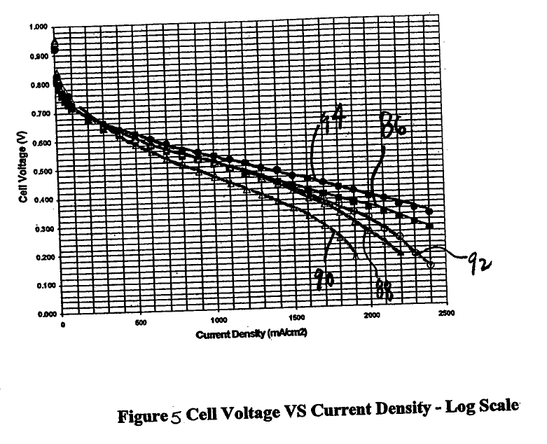

Referring to FIG. 5, a graph illustrating fuel cell performance for the Tanaka catalyst (see Example 17 above) and other carbon aerogel supported catalysts are shown. The graph is a plot of cell voltages (in volts) versus current densities (in milliamperes per square centimeter). Line 86 represents the operation of a fuel cell incorporating 0.2 mg/cm² of the Tanaka material wherein hydrogen is fed to the anode at 80 degrees C. at 0.2 liters per minute (L/min.) and air is fed at 80 degrees C. to the cathode at 0.5 L/min. Line 88 represents the operation of a fuel cell incorporating 0.1 mg/cm2 of 22 nm carbon aerogel supported 20% Pt catalyst wherein hydrogen is fed to the anode at 60 degrees C. at 200 ml/min. and oxygen is fed to the cathode at 60 degrees C. at 500 ml/min. Line 90 represents the operation of a fuel cell incorporating 0.1 mg/cm2 of 22 nm carbon aerogel supported 20% Pt catalyst wherein hydrogen is fed to the anode at 40 degrees C. at 200 ml/min. and oxygen is fed to the cathode at 40 degrees C. at 500 ml/min. Line 92 represents the operation of a fuel cell incorporating 0.1 mg/cm2 of 22 nm carbon aerogel supported 20% Pt catalyst wherein hydrogen is fed to the anode at 80 degrees C. at 200 ml/min. and air is fed to the cathode at 80 degrees C. at 500 ml/min. Line 94 represents another trial of the operation of a fuel cell incorporating 0.1 mg/cm2 of 22 nm carbon aerogel supported 20% Pt catalyst wherein hydrogen is fed to the anode at 80 degrees C. at 200 ml/min. and oxygen is fed to the cathode at 80 degrees C. at 500 ml/min. The operations of all fuel cells were at atmospheric pressure.

Although this invention has been shown and described with respect to the detailed embodiments thereof, it will be understood by those of skill in the art that various changes may be made and equivalents may be substituted for elements thereof without departing from the scope of the invention. In addition, modifications may be made to adapt a particular situation or material to the teachings of the invention without departing from the essential scope thereof. Therefore, it is intended that the invention not be limited to the particular embodiments disclosed in the above detailed description, but that the invention will include all embodiments falling within the scope of the appended claims.

1. A fuel cell electrode catalyst, comprising:
a carbon supporting structure comprising carbon aerogel, said carbon aerogel having a surface area of greater than about 400 m²/g and a pore size of greater than about 4 nm; and
a plurality of crystals of metal atoms dispersed on said supporting structure, said crystal being about 1 nm to about 4 nm in diameter.

2. The fuel cell electrode catalyst of claim 1, wherein said crystals of said metal atoms are dispersed on internal surfaces of said supporting structure and external surfaces of said supporting structure.

3. The fuel cell electrode catalyst of claim 1, wherein a dispersion rate of said particles of said metal is greater than about 35%.

4. The fuel cell electrode catalyst of claim 1, wherein a dispersion rate of said particles of said metal is greater than about 50%.

5. The fuel cell electrode catalyst of claim 1, wherein a dispersion rate of said particles of said metal is greater than about 70%.

6. The fuel cell electrode catalyst of claim 1, wherein a dispersion rate of said particles of said metal is greater than about 90%.

7. The fuel cell electrode catalyst of claim 1, wherein said crystals of said metal have chemically active surface areas of greater than about 100 m²/g.

8. The fuel cell electrode catalyst of claim 1, wherein said crystals of said metal have chemically active surface areas of greater than about 150 m²/g.

9. The fuel cell electrode catalyst of claim 1, wherein said crystals of said metal have chemically active surface areas of greater than about 200 m²/g.

10. The fuel cell electrode catalyst of claim 1, wherein said crystals of said metal have chemically active surface areas of greater than about 250 m²/g.

11. The fuel cell electrode catalyst of claim 1, wherein said cathode catalyst layer has a pore size of said supporting structure of greater than about 15 nm.

12. The fuel cell electrode catalyst of claim 1, wherein said anode catalyst layer has a pore size of said supporting structure of greater than about 15 nm.

13. The fuel cell electrode catalyst of claim 1, wherein said metal is selected from the group of metals consisting of iron, cobalt, magnesium, nickel, titanium, chromium, copper, platinum, gold, silver, rhodium, ruthenium, palladium, iridium, and combinations of the foregoing metals.

14. The fuel cell electrode catalyst of claim 1, wherein said metal is platinum and wherein said supporting structure has a metal content of greater than about 1 wt. % of total catalyst.

15. The fuel cell electrode catalyst of claim 1, wherein said metal is platinum and wherein said supporting structure has a metal content of greater than about 5 wt. % of total catalyst.

16. The fuel cell electrode catalyst of claim 1, wherein said metal is platinum and wherein said supporting structure has a metal content of greater than about 20 wt. % of total catalyst.

17. An MEA for a fuel cell, said MEA comprising:
a solid electrolyte membrane; and
electrode catalyst layers disposed on said solid electrolyte membrane, said electrode catalyst layers comprising an anode catalyst layer and a cathode catalyst layer;
wherein each of said electrode catalyst layer comprises a fuel cell electrode catalyst, said fuel cell electrode catalyst comprising,
a carbon supporting structure comprising carbon aerogel, said carbon aerogel having a surface area of greater than about 400 m²/g and a pore size of greater than about 4 nm, and
a plurality of crystals of metal atoms dispersed on said supporting structure, said crystal being about 1 nm to about 4 nm in diameter.

18. The MEA of claim 17, wherein said solid electrolyte membrane comprises a proton-conducting perfluorinated ionomer.

19. The MEA of claim 17, wherein a pore size of said catalyst supporting structure is greater than about 15 nm for the cathode catalyst layer.

20. The MEA of claim 17, wherein a pore size of said catalyst supporting structure is greater than about 15 nm for the anode catalyst layer.

21. The MEA of claim 17, wherein said metal is selected from the group of metals consisting of iron, cobalt, magnesium, nickel, titanium, chromium, copper, platinum, gold, silver, rhodium, ruthenium, palladium, iridium, and combinations of the foregoing metals.

22. The MEA of claim 17, wherein said electrode catalyst is deposited onto said solid electrolyte membrane as paste, slurry, or ink, said paste, slurry, or ink being in the form of a powder and a binder.

23. The MEA of claim 22, wherein said electrode catalyst is deposited onto said solid electrolyte membrane to a thickness of less than about 100 μm.

24. The MEA of claim 22, wherein said electrode catalyst is deposited onto said solid electrolyte membrane to a thickness of less than about 20 μm.

25. The MEA of claim 22, wherein said electrode catalyst is deposited onto said solid electrolyte membrane to a thickness of less than about 10 μm.

26. The MEA of claim 17, wherein said fuel cell is a PEM fuel cell.

27. The MEA of claim 17, wherein said fuel cell is a DM fuel cell.
